(19) United States
(12) Patent Application Publication
(10) Pub. No.: US 2018/0340509 A1
(43) Pub. Date: Nov. 29, 2018

(54) DEVICE FOR CONVERTING WIND ENERGY TO AT LEAST MECHANICAL ENERGY

(71) Applicant: Home Turbine B.V., Rijssen (NL)

(72) Inventor: William Erik VAN DER SCHEE, RIJSSEN (NL)

(21) Appl. No.: 15/761,575

(22) PCT Filed: Sep. 21, 2016
(86) PCT No.: PCT/NL2016/050648

§ 371 Date: Mar. 20, 2018

(30) Foreign Application Priority Data
Sep. 21, 2015 (NL) 1041476

(51) Int. Cl. F03D 1/04; F03D 9/34

(52) U.S. Cl. CPC F03D 1/04; F03D 9/34; F05B 2220/30; F05B 2240/12; F05B 2240/911; F05B 2250/502; F05B 2240/133; F05B 2220/706; F05B 2250/25

(57) ABSTRACT

The invention relates to a device for converting wind energy to at least mechanical energy, comprising a rotor drivable rotatably about a rotation axis by wind with a duct disposed therearound, wherein a central axis of the duct coincides with the rotation axis of the rotor, wherein the duct comprises a wind inlet opening and a wind outlet opening, and wherein the device is embodied such that in use of the device an air pressure in a central part of the wind outlet opening is lower than an air pressure at the wind inlet opening. The device can be provided for this purpose with a number of rear stator blades disposed downstream of the rotor in the duct for guiding the wind away in a downstream direction, which rear stator blades extend radially outward from the central axis.

### BACKGROUND OF THE INVENTION

### 1. Field of the Invention

The invention relates to a device for converting wind energy to at least mechanical energy.

### 2. Description of the Related Art

U.S. Pat. No. 4,021,135 A relates to a device for converting wind energy to at least mechanical energy, comprising a rotor drivable rotatably about a rotation axis by wind with a duct disposed therearound, wherein a central axis of the duct substantially coincides with the rotation axis of the rotor, wherein the duct comprises a wind inlet opening and a wind outlet opening, and wherein the device is embodied such that in use of the device an air pressure in at least a central part of the wind outlet opening is lower than an air pressure at the wind inlet opening.

More in particular, U.S. Pat. No. 4,021,135 A describes a ducted wind turbine with a rotor of the reaction type. This wind turbine is provided with augmenting means for producing a vortex downstream of the rotor at the wind outlet opening. The pressure difference along the length of the wind turbine is hereby increased, and thereby also the power which can be extracted from the wind.

It is an object of the invention to improve the per se known device. A particular object of the invention can be to increase the efficiency of the per se known device.

### SUMMARY OF THE INVENTION

This object is achieved with a device for converting wind energy to at least mechanical energy, comprising a rotor drivable rotatably about a rotation axis by wind with a duct disposed therearound, wherein a central axis of the duct substantially coincides with the rotation axis of the rotor, wherein the duct comprises a wind inlet opening and a wind outlet opening, and wherein the device is embodied such that in use of the device an air pressure in at least a central part of the wind outlet opening is lower than an air pressure at the wind inlet opening, wherein the device for converting wind energy to at least mechanical energy further comprises a number of rear stator blades disposed downstream of the rotor in the duct for guiding the wind away in a substantially downstream direction, which rear stator blades extend radially outward from the central axis

When a lower pressure prevails close to the wind outlet opening, particularly in at least a central part thereof, than close to the wind inlet opening, the airflow velocity of the wind in the duct can increase, whereby the efficiency of the device according to the invention can increase.

A device for converting wind energy to at least mechanical energy is also referred to as a wind turbine or windmill. The invention can relate particularly to a relatively small wind turbine, also referred to as a microturbine or urban wind turbine, which wind turbine can be set up in an urban environment, and in particular optionally on a building. The invention can relate more particularly to a so-called horizontal wind turbine, wherein in use of the wind turbine the rotation axis of the rotor and the central axis of the duct are disposed substantially horizontally.

The device according to the invention comprises various features which can each provide said function of providing a lower air pressure at the wind outlet opening than at the wind inlet opening and which can if desired each be applied separately or if desired in any suitable combination.

A first feature of the device according to the invention is therefore that it has a number of rear stator blades disposed downstream of the rotor in the duct for guiding the wind away in a substantially downstream direction, which rear stator blades extend radially outward from the central axis.

A vacuum can occur on the underpressure side of the rotor blades. Because of this vacuum the airflow round the rotor blades coming from the rotor tends to turn in the direction of the vacuum created there, whereby air vortices occur. These air vortices decrease the efficiency of the rotor because the pressure difference over the front and rear side of the rotor blades decreases as seen in rotation direction. Using the rear stator blades disposed downstream of the rotor the airflow or wind is guided away in a substantially downstream direction. This prevents or at least reduces the possibility of the airflow round the rotor blades turning and vortices occurring behind the rotor blades. The efficiency of the device according to the invention can in this way increase.

Another feature of the device according to the invention can be that a part of the duct extending from the rotor to the wind outlet opening widens as seen in flow direction, wherein the height of the rear stator blades increases in downstream direction along the length of the rear stator blades.

Because of the widening duct the wind from the rotor flowing therein will be guided radially outward to some extent relative to the central axis in the direction of the inner surface of the duct. The airflow is hereby distributed as uniformly as possible over the duct surface, this resulting in the intended lower pressure in at least a central part of the wind outlet opening relative to the pressure at the wind inlet opening.

Because of the widening duct the wind flowing directly outside the duct will be guided outward relative to the central axis, wherein the flow distance of the wind flowing directly on the outer side of the duct increases and the direction thereof changes, so that the wind flow flowing out of the wind outlet opening will flow in the direction of the wind flowing on the outer side, i.e. in an outward direction relative to the central axis of the duct. This results in the intended lower pressure in at least a central part of the wind outlet opening relative to the pressure at the wind inlet opening.

Said part of the duct can in particular substantially take the form of a Venturi.

In yet another embodiment of the device according to the invention each rear stator blade is provided with a number of upright ribs extending from a pressure side thereof, which ribs extend from a wind entry side of the blade to a wind exit side of the rear stator blade, wherein the ribs extend radially outward with a determined curvature over said side such that on the wind exit side each rib is located at a greater radial distance from the central axis than on the wind entry side.

The ribs provide the advantage that they guide the airflow from the rotor substantially radially outward, which results in the intended lower pressure in at least a central part of the wind outlet opening relative to the pressure at the wind inlet opening.

The ribs can here have a height lying between 0.1% and 25% of the maximum height of the stator blade.

A feature of the device according to the invention can be that the duct is embodied such that a length on the inner side of the duct between the wind inlet opening and the wind outlet opening is shorter than the length on the outer side of the duct between the wind inlet opening and the wind outlet opening.

Owing to the shorter length of the duct on the inner side than on the outer side thereof and the change in direction of the duct on the outer side at the position of the wind outlet opening, the flow distance of wind flowing through the duct is shorter than a flow distance of wind flowing directly on the outer side of the duct and the flow direction of wind flowing directly on the outer side of the duct is oriented outward at the position of the wind outlet opening. When a velocity of supplied wind increases, the pressure on the outer side of the duct will hereby be lower at the wind outlet opening, whereby the wind flowing out of the wind outlet opening will flow in the direction of the wind flowing on the outer side, i.e. in an outward direction relative to the central axis of the duct. This results in the intended lower pressure in at least a central part of the wind outlet opening relative to the pressure at the wind inlet opening.

An outlet angle of the wind outlet opening can make an angle with the central axis which is greater than 0° and a maximum of 90° and which lies more particularly between 60-90°.

An advantage of such an outlet angle is that the wind flowing out of the duct is guided radially outward, whereby the intended lower pressure than at the wind inlet opening is created in at least a central part of the wind outlet opening.

It is noted that the duct can comprise any suitable cross-sectional form. The duct here preferably has a circular cross-sectional form at least in the area of the rotor so that the part of the duct where the rotor is disposed is substantially cylindrical. The wind inlet opening and/or the wind outlet opening of the duct can also have a substantially circular cross-section. In that case the duct preferably has a circular cross-sectional form at any random location along its length. The wind inlet opening and/or the wind outlet opening can alternatively have any other suitable cross-sectional form, such as for instance oval. In the case of such a non-circular cross-sectional form of the wind inlet opening and/or the wind outlet opening the duct preferably transposes gradually to the circular cross-sectional form in the area of the rotor.

A maximum cross-sectional dimension of the wind outlet opening of the duct, in particular an outer diameter in the case of a circular wind outlet opening, can be greater than a maximum cross-sectional dimension of the wind inlet opening of the duct, in particular an outer diameter in the case of a circular wind inlet opening.

The greater cross-sectional dimension of the wind outlet opening relative to the wind inlet opening contributes toward the intended lower pressure at the wind outlet opening than at the wind inlet opening.

Another feature of the device according to the invention can be that the outer periphery of the duct is provided with a helical upright rib.

The helical rib lengthens the flow distance of the wind flowing directly on the outer side of the duct and changes the flow direction of the wind flowing directly on the outer side of the duct so that the wind flow flowing out of the wind outlet opening will flow in the direction of the wind flowing on the outer side, i.e. in an outward direction relative to the central axis of the duct. This results in the intended lower pressure in at least a central part of the wind outlet opening relative to the pressure at the wind inlet opening.

Another effect of the helical rib can be that the ambient air around the wind turbine can begin to swirl, whereby the air resistance on the outer side of the duct increases. The wind flowing directly on the outer side of the duct will hereby encounter resistance, whereby the velocity of the wind flowing directly on the outer side of the duct will decrease. The wind flow flowing out of the wind outlet opening will, as elucidated above, hereby flow in the direction of the wind flowing on the outer side, i.e. in an outward direction relative to the central axis of the duct, this resulting in the intended lower pressure in at least a central part of the wind outlet opening relative to the pressure at the wind inlet opening.

The rib can have a height lying between 4 and 25%, more particularly between 4 and 10%, of the maximum cross-sectional dimension of the duct.

Applicant has found that a rib with such a height can produce the desired effect. A higher rib is also possible, although it will produce no, or at least little, extra effect but will cost additional material.

Another feature of the device according to the invention can be that the device comprises at least one substantially annular element disposed concentrically with the central axis close to the wind outlet opening and having a smaller cross-sectional dimension than the wind outlet opening, wherein the or each substantially annular element comprises a peripheral surface which widens in downstream direction.

Because of the peripheral surface of the substantially annular element which widens in downstream direction, i.e. the cross-sectional dimension of the substantially annular element increases in downstream direction, the air will be guided outward to some extent by the substantially annular element so that the wind flow flowing out of the wind outlet opening will flow in the direction of the wind flowing on the outer side, i.e. in an outward direction relative to the central axis of the duct. This results in the intended lower pressure in at least a central part of the wind outlet opening relative to the pressure at the wind inlet opening.

It is noted that the substantially annular element can have any suitable cross-sectional form, such as circular, but also non-circular, for instance oval. The substantially annular element can particularly have a form adapted to the local cross-sectional form of the duct. The local cross-sectional form is understood here to mean the cross-sectional form of the part of the duct situated at the same position in radial direction.

The widening annular element can widen in any suitable manner. In an embodiment of the device according to the invention the peripheral surface extends obliquely outward in downstream direction at an angle to the central axis. The substantially annular element in this way widens in a substantially tapering manner.

Said angle of the peripheral surface to the central axis can for instance be greater than 0° and smaller than 60°.

In yet another embodiment the device according to the invention can be provided with at least one valve which is arranged on the wind outlet opening of the duct and which is adjustable between a first open state, in which the at least one valve leaves the wind outlet opening substantially clear, and a second closing state in which the at least one valve substantially closes at least a part of the wind outlet opening. This prevents air flowing back into the wind turbine when the wind changes direction and/or changes speed.

A structurally simple embodiment is then obtained when the at least one valve is a non-return valve such that the at least one valve adjusts automatically from its closing state to its open state when the wind flows from the wind inlet opening to the wind outlet opening, and adjusts automatically from its open state to its closing state when the wind threatens to flow into the duct through the wind outlet opening. This can for instance be detected by an anemometer or wind angle meter which can generate a signal to a drive connected to the valve.

This effect can be achieved in very simple manner when the at least one valve is manufactured from a flexible material. The valve then deforms when the approach direction or angle changes, and a separate control of the valve is then not necessary.

The at least one valve can extend here over at least a part of the periphery of the outlet opening and be connected with one peripheral end zone thereof to the duct, while the other peripheral end zone is freely suspended.

The invention will be further elucidated with reference to the drawings

### BRIEF DESCRIPTION OF THE DRAWINGS

FIGS. 1A-1D show schematically the wind turbine according to a first embodiment of the invention, wherein FIG. 1A is a perspective view from a wind inlet side, FIG. 1B is a side view, FIG. 1C is a perspective view from a wind outlet side, and FIG. 1D is a longitudinal vertical cross-section;

FIG. 2 shows schematically a perspective view of rotor and guide blades disposed in a duct of the wind turbine of FIG. 1;

FIGS. 3A and 3B show schematically in detail the valves on the wind outlet opening, wherein FIG. 3A shows the valves in an open state and FIG. 3B shows the valves in a closing state;

FIGS. 4A-4C show schematically a nanostructure which can be arranged on a number of surfaces of the wind turbine, wherein FIG. 4A is a top view of the nanostructure, FIG. 4B shows a detail of FIG. 4A and FIG. 4C shows a cross-section through the nanostructure.

FIGS. 5A-5C show schematically a rotor of the wind turbine of FIG. 1, wherein FIG. 5A is a perspective front view, FIG. 5B is a front view, FIG. 5C is a section in the longitudinal direction of the rotor of FIG. 5B; FIG. 5D shows a pressure side of a rotor blade and FIG. 5E is a rear view of the rotor blade; and

FIGS. 6A and 6B show schematically the wind turbine according to a second embodiment of the invention, wherein FIG. 6A is a perspective view from a wind inlet side and FIG. 6B is a front view.

### DETAILED DESCRIPTION

The various aspects of the invention will be elucidated with reference to the figures. The same elements will be designated here with the same reference numerals. The different aspects of the invention can be applied individually or in any random combination.

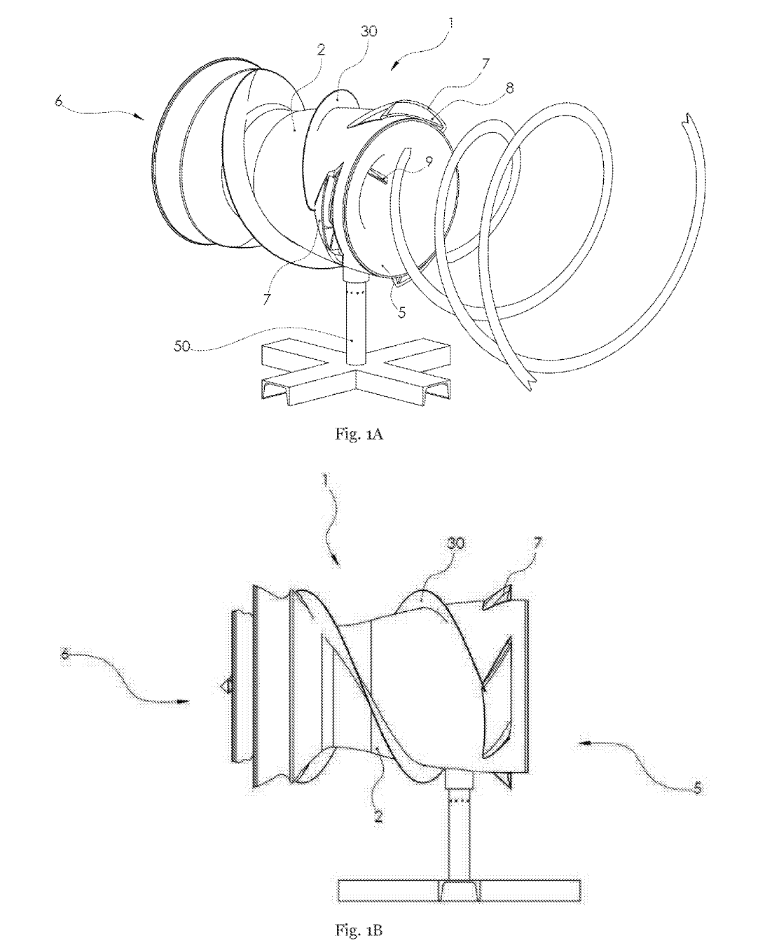

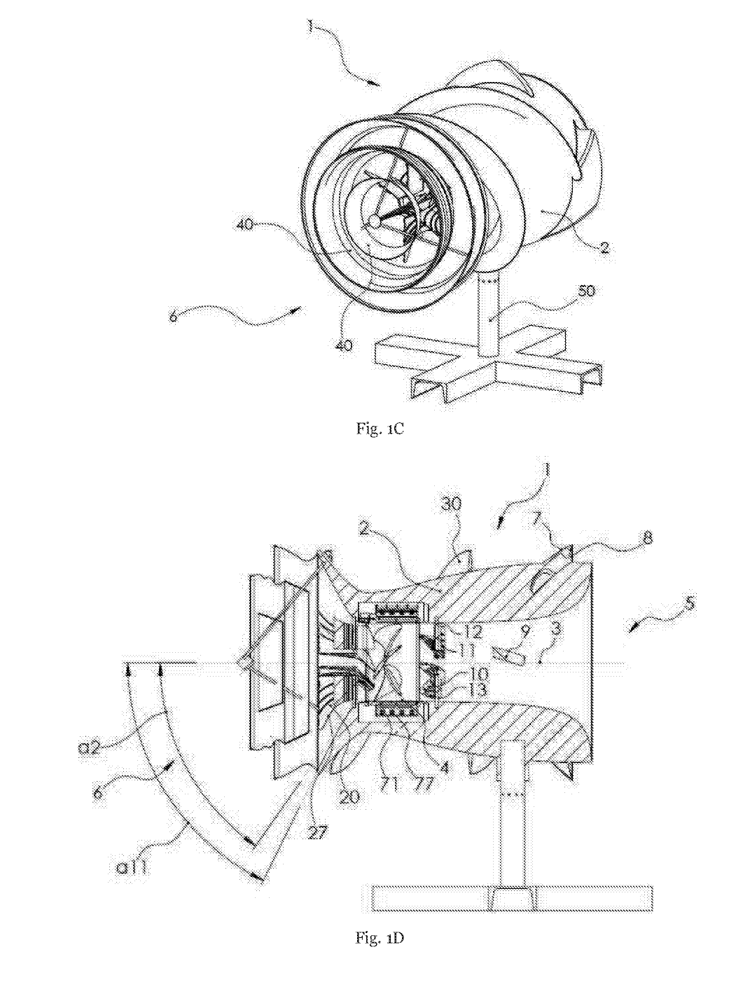

FIGS. 1A-1D show a wind turbine 1 according to a first embodiment of the invention. Wind turbine 1 comprises a duct 2 with a central axis 3. A rotor 4 is disposed in duct 2, wherein the central axis 3 of duct 2 substantially coincides with a rotation axis of rotor 4. Duct 2 has a wind inlet opening 5 and a wind outlet opening 6. In this first embodiment wind inlet opening 5 and wind outlet opening 6 are circular.

According to an aspect of the invention, duct 2 is provided on its outer side close to wind inlet opening 5 with a number of wind capture elements 7, in this example three, extending radially outward. Each wind capture element 7 is provided with a channel 8 extending to the inner side of duct 2. The three wind capture elements 7 are arranged distributed at an equal mutual angular distance over the outer surface of duct 2. Each channel 8 extends over substantially its full length in helical form in flow direction round the central axis through duct 2, and debouches with an outlet opening 9 on the inner surface of duct 2. Wind capture elements 7 capture wind flowing on the outer side of duct 2 and feed this wind in helical form to the inner surface of duct 2 via outlet openings 9.

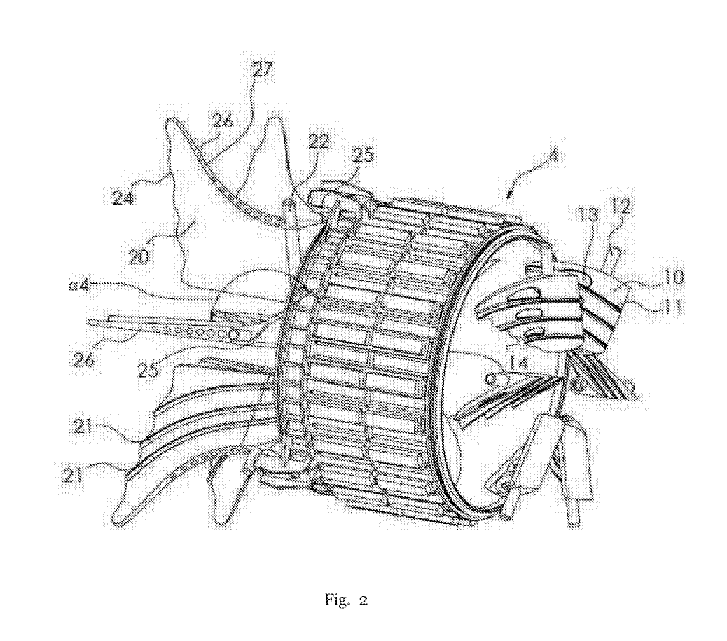

According to another aspect of the invention, see also FIG. 2, wind turbine 2 comprises a number of stator blades 10, in this example six, which are disposed upstream of rotor 4 in duct 2 and which extend radially outward from the central axis 3. Stator blades 10 have a main plane which extends radially from central axis 3 and which is disposed at an oblique angle relative to central axis 3. Because of the oblique angle of the main plane of stator blades 10 the wind flow flowing in duct 2 is guided in an oblique direction relative to central axis 3 so that the wind flow is guided in a substantially helical movement round the central axis 3. Each stator blade 10, in particular the main plane thereof, is provided with a number of upright ribs 11, in this example three. The upright ribs 11 extend from the pressure side of each stator blade 10 from an upstream wind entry side of blade 10 to a downstream wind exit side of stator blade 10. Ribs 11 extend obliquely outward as seen in radial direction over the wind guiding surface so that on the wind exit side each rib 11 is located at a greater radial distance from the central axis than on the wind entry side. The ribs support the change in the flow direction of the airflow to said helical movement round central axis 3. The desired angle of the helical movement of the wind round central axis 3 is preferably adjustable. Stator blades 10 are connected for this purpose to a connecting shaft 12 extending radially from central axis 3, which connecting shafts 12 are each connected at their radial outer end to duct 2. Stator blade 10 is pivotable about or with connecting shaft 12 for the purpose of adjusting the oblique angle of stator blade 10 relative to central axis 3. Each stator blade 10 is provided with a number of openings 13, in this example three. On the wind exit side each stator blade 10 is provided with a substantially sine-shaped end edge 14, the second derivative of which changes sign more than once.

According to another aspect of the invention, see FIG. 1D, the inner side of duct 2 takes the form, from wind inlet opening 5 up to for instance the location where connecting shaft 12 is disposed, of a Venturi narrowing in flow direction. In a part of duct 2 where rotor 4 is disposed the inner side of duct 2 is substantially cylindrical. Particularly the combination of the Venturi form of the inner side of duct 2 and the stator blades 10 ensures that the wind flows in helical form with a radially outward component upstream of the stator blades 10, so that the diameter of the wind flow supplied to wind turbine 2 upstream of wind inlet opening 5 increases in upstream direction, see also FIG. 1A.

According to another aspect of the invention, see FIG. 1D and FIG. 2, wind turbine 2 comprises a number of rear stator blades 20, in this example six, disposed in duct 2 downstream of rotor 4 and substantially connecting thereto for guiding the wind away from rotor 4 in a substantially downstream direction. Rear stator blades 20 extend radially outward from central axis 3. Each rear stator blade 20 is provided with a number of upright ribs 21, in this example three. Upright ribs 21 extend from the pressure side of each rear stator blade 20 from an upstream wind entry side of blade 20 to a downstream wind exit side of rear stator blade 20. Ribs 21 extend obliquely outward as seen in radial direction with a determined curvature over the wind guiding surface so that on the wind exit side each rib 21 is located at a greater radial distance from central axis 3 than on the wind entry side. Ribs 21 substantially convert a possible helical airflow coming from rotor 4 to a radially outward expanding airflow flowing substantially parallel to central axis 3. The angle of rear stator blades 20 to the central axis is preferably adjustable. Rear stator blades 20 are connected for this purpose to a connecting shaft 22 extending radially from central axis 3, which connecting shafts 22 are each connected at their radial outer end to duct 2. Rear stator blade 20 is pivotable about or with connecting shaft 22 for the purpose of adjusting the angle of rear stator blade 20 relative to central axis 3. On the wind exit side each rear stator blade 20 is provided with a substantially sine-shaped end edge 24, the second derivative of which changes sign more than once. Each rear stator blade 20 has substantially two blade parts 25, 26 disposed at an angle α4 relative to each other, wherein blade part 25 substantially connects to rotor 4 and blade part 26 is disposed downstream of blade part 25. Depending on the adjusted angle of rear stator blade 20, blade part 25 can extend substantially at an angle to central axis 3 and blade part 26 can extend substantially parallel to central axis 3. The angle α1 between blade parts 25, 26 is in this example around 130°. Blade part 26 has an increasing height so that the wind is guided substantially radially outward, and thereby expands. The increasing height of blade part 26 is optionally adapted to the form of the inner side of that part of duct 2 where blade part 26 is disposed, as will be further elucidated below.

According to another aspect of the invention, see FIG. 1D, a part of duct 2 extending from rotor 4 to wind outlet opening 6 widens in flow direction, particularly in the form of a Venturi. Duct 2 widens in Venturi form particularly on both its inner side and its outer side. Due to the Venturi form of the outer side of duct 2 the airflow flowing on the outer side of duct 2 is guided radially outward to some extent, whereby an underpressure is created in the area of outlet opening 6. An outlet angle α11 of wind outlet opening 6 to central axis 3 is in this example about 60°.

As elucidated above with reference to rear stator blades 20 and as shown in FIG. 1D and FIG. 2, the height of blade part 26 can be adapted here to the inner side of duct 2 widening in the form of a Venturi. A tangent of an upper edge 27 of each rear stator blade 20, and in particular of blade part 26 thereof, can make an angle α2 with central axis 3 which is adapted to the inner side of duct 2 widening in the form of a Venturi, and thereby increases in this example along its length in downstream direction from about 20° to about 80°.

According to another aspect of the invention, duct 2 has a thickness and/or form such that the flow distance of the wind through duct 2 is smaller than the flow distance round the outer side of duct 2, and that because of the form the flow direction round the outer side of duct 2 changes direction at the position of wind outlet opening 6. An underpressure is hereby created in the area of outlet opening 6.

According to another aspect of the invention, the diameter of wind outlet opening 6 of the duct is greater than an outer diameter of wind inlet opening 5 of duct 2.

According to another aspect of the invention, the outer periphery of duct 2 is provided with a helical upright rib 30. This lengthens the flow distance of the wind on the outer side of duct 2 compared to the flow distance of the wind through the inner side of duct 2, and it changes the flow direction round the outer side of duct 2. An underpressure is hereby created in the area of outlet opening 6.

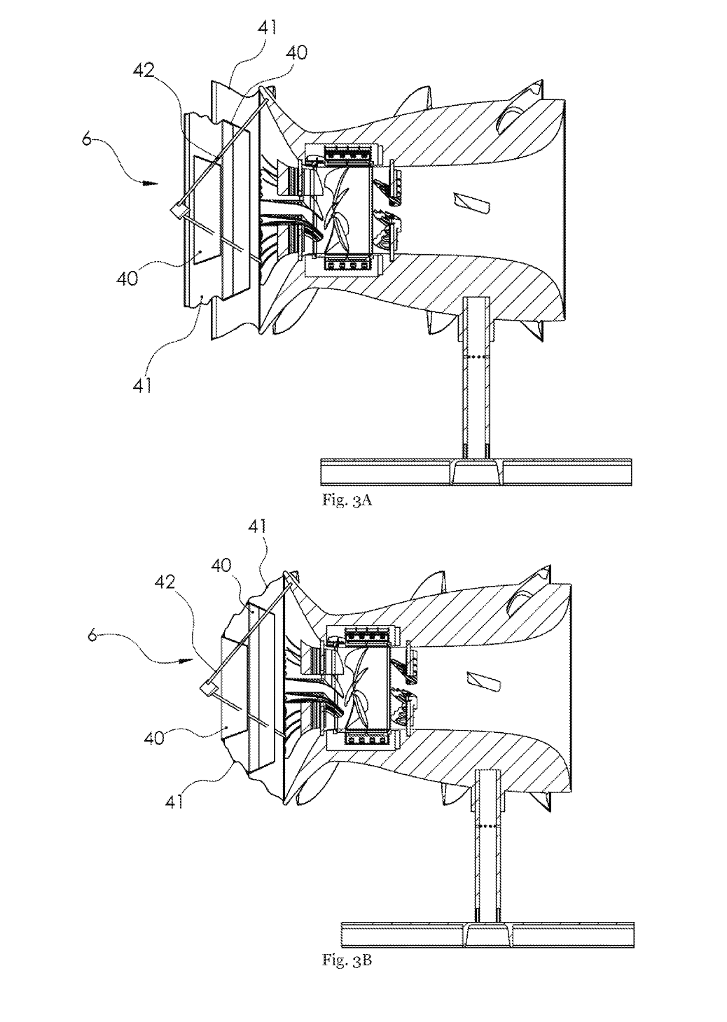

According to another aspect of the invention, see also FIGS. 3A, 3B, wind turbine 1 is provided in the area of wind outlet opening 6 of duct 2 with a number of annular elements 40, in this case two, disposed concentrically with outlet opening 6. Annular elements 40 each have a different diameter which are both smaller than the diameter of outlet opening 6. Annular elements 40 each comprise a cylindrical peripheral surface which extends obliquely outward in downstream direction at an angle to central axis 3. Annular elements 40 are therefore substantially conically widening annular elements. Due to the outward tapering form of annular elements 40 the wind flowing out of outlet opening 6 is guided radially outward. Arranged on duct 2 extending over the periphery of outlet opening 6 is a flexible valve 41 which is connected with one end zone to duct 2. Arranged on the outer annular element 40 is a flexible valve 41 which extends over the periphery thereof and which is connected with one end zone to annular element 40. In FIG. 3A valves 41 are shown in their open state, in which they leave outlet opening 6 substantially clear. The wind flowing out of wind outlet opening 6 moves the valves automatically into this open state. When the wind turns and threatens to flow into duct 2 via outlet opening 6, the wind pushes valves 41 automatically to their closing state as shown in FIG. 3B. In the closing state the valve 41 connected to duct 2 lies with its free end zone against the outer annular element 40, and the valve connected to the outer annular element 40 lies against the inner annular element 40 so that valves 41 substantially close at least the peripheral zone of wind outlet opening 6. Particularly the valve 41 connected to outlet opening 6 substantially closes the space between outlet opening 6 and the outer annular element 40. Particularly the valve 41 connected to outer annular element 40 substantially closes the space between outer annular element 40 and inner annular element 40. Bounding elements in the form of rods 42 extend between the peripheral end zone of outlet opening 6 of duct 2 and outer annular element 40 and between outer annular element 40 and inner annular element 40. These rods 42 prevent the flexible valves 41 blowing the valves 41 further inward from their closing state by the wind threatening to flow into outlet opening 6. In this example the inner annular element 40 is not provided with a valve, so that a central part of outlet opening 6 cannot be closed. This inner annular element 40 can if desired also be provided with a valve so that the central part of outlet opening 6 can be closed and outlet opening 6 can be substantially completely closed.

Wind turbine 1 according to the invention can particularly be a relatively small wind turbine, also referred to as a microturbine or urban wind turbine, which wind turbine can be set up in an urban environment, and in particular optionally on a building. Wind turbine 2 can for this purpose comprise a leg 50, using which the wind turbine can be set up. As shown in the figures, wind turbine 1 is particularly a so-called horizontal wind turbine, wherein the rotation axis of the rotor and the central axis 3 of duct 2 are disposed substantially horizontally during use of wind turbine 1.

An inner surface of the duct and/or rotor blades of the rotor is/are provided with a structure, which structure has a pattern of recesses for receiving substantially stationary air.

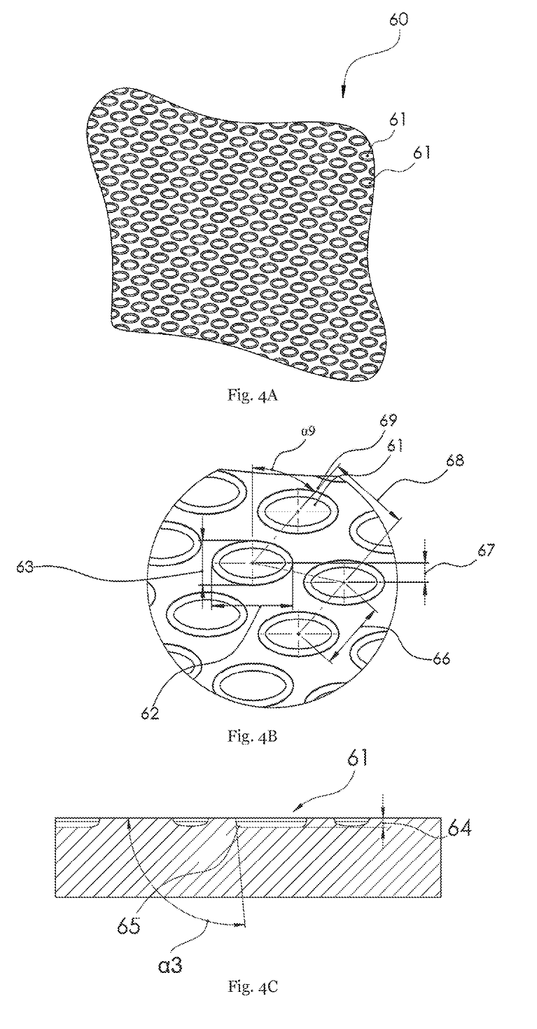

FIGS. 4A-4C show a nanostructure 60 which can for instance be arranged on the inner surface of duct 2 and/or on stator blades 10 and/or on rear stator blades 20. Nanostructure 60 has a pattern of recesses 61 for receiving substantially stationary air. The dimensions of recesses 61 lie in the order of magnitude of several μm to several mm. In this example the dimensions are substantially oval, but can take any desired form. In this example the length 62 of each recess is about 4.2 mm. The width 63 of each recess in this example is about 2.3 mm. In this example the depth 64 of each recess is about 0.7 mm. The peripheral wall of each recess 61 extends in this example at an angle α3 to the inner surface of the duct and/or the surface of stator blade 10 and/or rear stator blade 20, wherein the angle α8 is in this example about 95°. The peripheral wall of each recess 61 is connected in this example at a rounded angle 65 to the bottom of each recess, wherein the rounded angle 65 in this example has a radius of about 0.6 mm. In this example the recesses 61 are disposed adjacently of each other in a number of substantially straight lines 69, wherein the straight line extends at an angle α4 relative to the central axis 3, wherein the angle α4 in this example is about 41°. In this example a centre-to-centre distance 66 between two recesses 61 disposed in one line adjacency of each other is about 3.8 mm. In this example recesses 61 of two mutually adjacent lines 69 of recesses 61 are disposed offset relative to each other, wherein the offsetting 67 in a direction perpendicularly of the longitudinal direction of duct 2 is in this example about 1.1 mm. A centre-to-centre distance 68 between two adjacent recesses 61 of adjacent lines 69 is in this example about 5.2 mm.

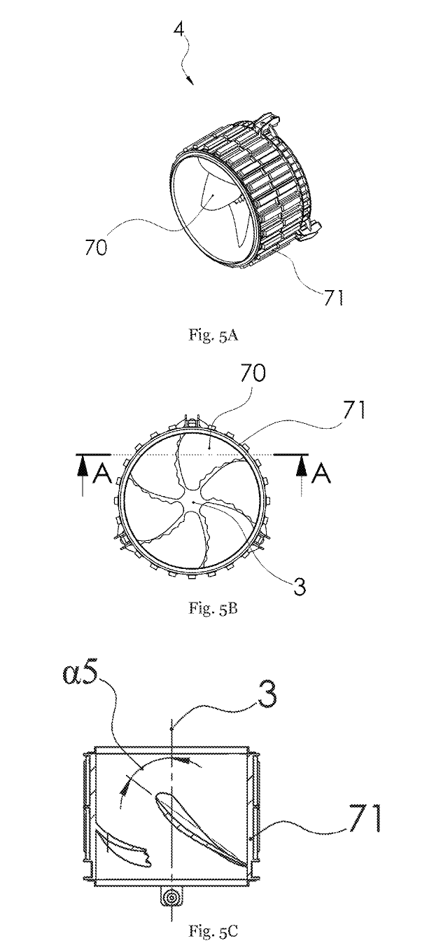

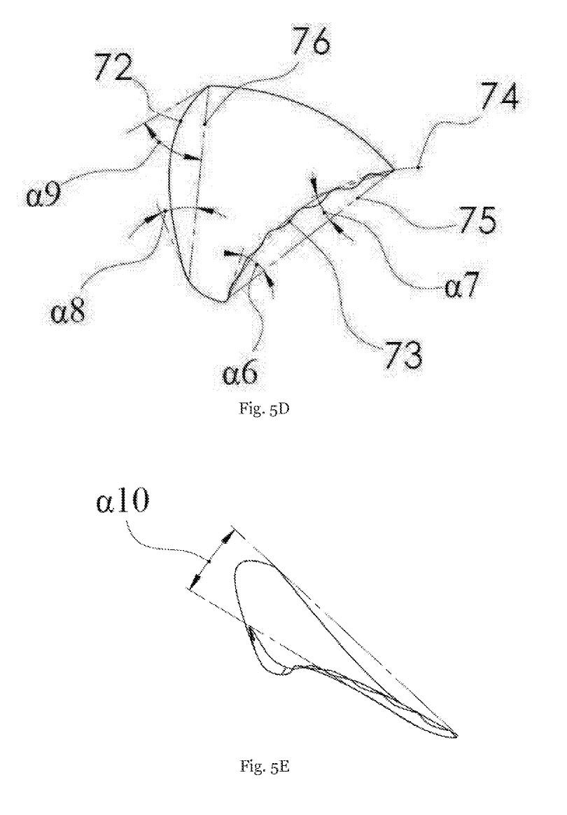

FIGS. 5A-5E show a rotor according to an aspect of the invention. The rotor comprises a number of rotor blades 70, in this example six, which are connected with a peripheral edge to a rotor body 71 of a generator, see also FIG. 1D. Rotor 4 is driven rotatingly by a wind flow flowing in duct 2, whereby rotor body 71 co-rotates. A stator body 77 of the generator disposed in duct 2 is arranged round rotor body 71, see FIG. 1D. As shown in FIG. 5C, rotor blades 70 are disposed at an angle α5 to rotation axis 3, this angle α5 being about 53° in this example. As shown in, among others, FIGS. 5A, 5B and 5D, the rotor blades have a wind entry side with a front end edge 72 and a wind exit side with an end edge 73. End edge 73 is substantially sine-shaped over a curved main line 74. An angle α6 of main line 74 close to an inner end of end edge 73, which is disposed close to the rotation axis coinciding with central axis 3, relative to a straight line 75 between the inner end and the outer end of end edge 73, which is disposed close to rotor body 71, is in this example about 38°. An angle α7 of the main line 74 close to the outer end of end edge 73 relative to the straight line 75 between the inner end and the outer end is in this example about 17°. The front end edge 72 is substantially arcuate. An angle α8 of front end edge 72 close to an inner end of front end edge 72, which is disposed close to the rotation axis coinciding with central axis 3, relative to a straight line 76 between the inner end and the outer end of front end edge 72, which is disposed close to rotor body 71, is in this example about 28°. An angle α14 of front end edge 72 close to the outer end of front end edge 72 relative to the straight line 76 between the inner end and the outer end is in this example about 48°. As can be seen in, among others, FIGS. 5C and 5E, rotor blades 70 are twisted in a direction between an inner end zone and the peripheral edge connected to generator body 71, in this example through an angle α15 of about 5°.

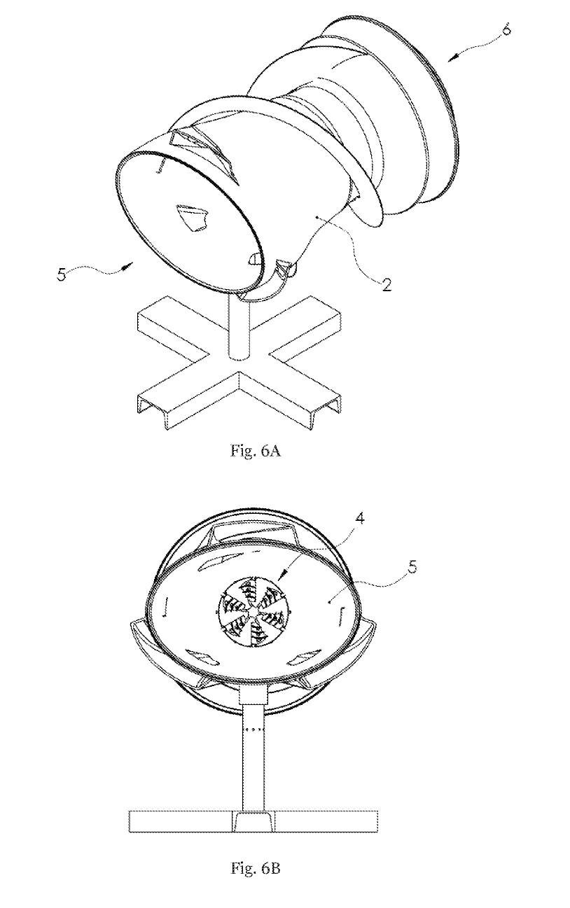

FIGS. 6A and 6B show a wind turbine 1 according to a second embodiment of the invention. Only the differences from the wind turbine of FIGS. 1-5 will be elucidated here, and for a further specification of FIGS. 6A and 6B reference is made to the figure description associated with FIGS. 1-5.

Wind turbine 1 according to the second embodiment of the invention differs from the wind turbine according to the first embodiment in that inlet opening 5 and outlet opening 6 are substantially oval-shaped instead of circular. Duct 2 transposes gradually from its oval end zones or openings 5, 6 to a round cross-sectional form so that the part of duct 2 where rotor 4 is disposed is substantially cylindrical, just as in the wind turbine according to the first embodiment.

It is noted that the invention is not limited to the shown embodiments but also extends to variants within the scope of the appended claims.

The stated values for dimensions, angles and the like are thus given only by way of example. Applicant has found that said values are particularly suitable, but the invention is thus not limited thereto.

It will also be apparent that the form of the inlet opening and/or outlet opening is not limited to the shown circular shape or oval shape, but that it can have any suitable shape. The part where the rotor is disposed is however preferably of circular cross-section, and thereby cylindrical, wherein in the case of a non-circular inlet opening or non-circular outlet opening a gradual transition to this cylindrical part will take place.

1. Device for converting wind energy to at least mechanical energy, comprising a rotor drivable rotatably about a rotation axis by wind with a duct disposed therearound, wherein a central axis of the duct substantially coincides with the rotation axis of the rotor, wherein the duct comprises a wind inlet opening and a wind outlet opening, and wherein the device is embodied such that in use of the device an air pressure in at least a central part of the wind outlet opening is lower than an air pressure at the wind inlet opening, wherein the device for converting wind energy to at least mechanical energy further comprises a number of rear stator blades disposed downstream of the rotor in the duct for guiding the wind away in a substantially downstream direction, which rear stator blades extend radially outward from the central axis.

2. Device as claimed in claim 1, wherein a part of the duct extending from the rotor to the wind outlet opening widens as seen in flow direction, and wherein the height of the rear stator blades increases in downstream direction along the length of the rear stator blades.

3. Device as claimed in claim 2, wherein said part of the duct is formed as a Venturi.

4. Device as claimed in claim 1, wherein each rear stator blade is provided with a number of upright ribs extending from a pressure side thereof, which ribs extend from a wind entry side of the blade to a wind exit side of the rear stator blade, wherein the ribs extend radially outward with a determined curvature over said side such that on the wind exit side each rib is located at a greater radial distance from the central axis than on the wind entry side.

5. Device as claimed in claim 4, wherein the ribs have a height lying between 0.1% and 25% of the maximum height of the stator blade.

6. Device as claimed in claim 1, wherein the duct is embodied such that a length on the inner side of the duct between the wind inlet opening and the wind outlet opening is shorter than the length on the outer side of the duct between the wind inlet opening and the wind outlet opening.

7. Device as claimed in claim 1, wherein an outlet angle of the wind outlet opening makes an angle with the central axis which is greater than 0° and a maximum of 90°.

8. Device as claimed in claim 2, wherein a maximum cross-sectional dimension of the wind outlet opening of the duct is greater than a maximum cross-sectional dimension of the wind inlet opening of the duct.

9. Device as claimed in claim 1, wherein the outer periphery of the duct is provided with a helical upright rib.

10. Device as claimed in claim 9, wherein the rib has a height lying between 4 and 10% of the maximum cross-sectional dimension of the duct.

11. Device as claimed in claim 1, comprising at least one annular element disposed concentrically with the central axis close to the wind outlet opening and having a smaller cross-sectional dimension than the wind outlet opening, wherein the or each substantially annular element comprises a peripheral surface which widens in downstream direction.

12. Device as claimed in claim 11, wherein the peripheral surface extends obliquely outward in downstream direction at an angle to the central axis.

13. Device as claimed in claim 12, wherein said angle is greater than 0° and smaller than 60°.

14. Device as claimed in claim 1, comprising at least one valve which is arranged on the wind outlet opening of the duct and which is adjustable between a first open state, in which the at least one valve leaves the wind outlet opening substantially clear, and a second closing state in which the at least one valve substantially closes at least a part of the wind outlet opening.

15. Device as claimed in claim 14, wherein the at least one valve is a non-return valve such that the at least one valve adjusts automatically from its closing state to its open state when the wind flows from the wind inlet opening to the wind outlet opening, and adjusts automatically from its open state to its closing state when the wind threatens to flow into the duct through the wind outlet opening.

16. Device as claimed in claim 14, wherein the at least one valve is manufactured from a flexible material.

17. Device as claimed in claim 16, wherein the at least one valve extends over at least a part of the periphery of the outlet opening and is connected with one peripheral end zone thereof to the duct, and wherein the other peripheral end zone is freely suspended.

18. Device as claimed in claim 1, wherein an outlet angle of the wind outlet opening makes an angle with the central axis which lies between 60-90°.

19. Device as claimed in claim 9, wherein the rib has a height lying between 4 and 10% of the maximum cross-sectional dimension of the duct.
